(19) United States
(12) Patent Application Publication
(10) Pub. No.: US 2010/0295785 A1
(43) Pub. Date: Nov. 25, 2010

(54) INTERACTIVE SYSTEM AND OPERATING METHOD THEREOF

(75) Inventors: Chih Hung LU, Hsin-Chu County (TW); Cho Yi LIN, Hsin-Chu County (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Hsin-Chu County (TW)

(21) Appl. No.: 12/782,744

(22) Filed: May 19, 2010

(30) Foreign Application Priority Data
May 19, 2009 (TW) 098116652

(51) Int. Cl. G09G 5/08

(52) U.S. Cl. 345/159

(57) ABSTRACT

An integrative image system includes an image display, a first input device, a second input device and a host. When at least one key of the first input device is pressed, the first input device sends a control signal to the host to enable the host to compare a characteristic parameter detected by the second input device with a plurality of predetermined rules and to control the image display to execute a corresponding function according to the predetermined rule that the characteristic parameter matches. The present invention further provides an operating method of an interactive image system.

### CROSS REFERENCE TO RELATED APPLICATION

This application claims the priority benefit of Taiwan Patent Application Serial Number 098116652, filed on May 19, 2009, the full disclosure of which is incorporated herein by reference.

### BACKGROUND

1. Field of the Invention

This invention generally relates to an interactive image system and an operating method thereof and, more particularly, to an interactive image system with extendable functions according to a characteristic parameter detected by an input device and an operating method of the interactive image system.

2. Description of the Related Art

Please refer to FIG. 1, it shows a schematic diagram of an image display system 9. The image display system 9 includes a host 91, an image display 92, a keyboard 93 and a mouse 94, wherein the host 91 is electrically connected to the image display 92 for communicating information therebetween; the keyboard 93 and the mouse 94 are wirelessly or electrically connected to the host 91 for transmitting control signals thereto.

The mouse 94 generally includes a plurality of function keys 941 and a roller 942. The mouse 94 is for detecting a displacement and then transmits the detected displacement to the host 91 for correspondingly controlling the movement of a cursor 921 shown on the image display 92 and the update of images shown by the image display 92, e.g. performing icon selection function with the function key 941 or performing scrolling function with the roller 942, wherein a method that the mouse 94 detects the displacement is based on the correlation between successive images detected by the mouse 94. The method for calculating displacement according to successive images may refer to the disclosure in U.S. Pat. No. 5,729,008, entitled “Method and Device for tracking Relative Movement by Correlating Signals from an Array of Photoelements”.

The keyboard 93 may include a plurality of keys 931 for being used to input control signals or symbols to the software run by the host 91 to enable the image display 92 to display corresponding images. In addition, when a “Ctrl” key of the keyboard is pressed and the roller 942 of the mouse 94 is rolled simultaneously, zoom in or zoom out function can be further executed.

As only a few control components, e.g. the function key 941 and the roller 942, are manufactured on the mouse 94 so as to reduce the manufacturing cost and to simplify the operating procedure, when a user would like to use the mouse 94 to execute other operating functions, e.g. flipping pages, object rotating, window expanding or window shrinking, these functions can not be executed by only using these limited control components.

Accordingly, it is necessary to further provide an interactive image system that can expand the operating function of an interactive image system according to a characteristic parameter, such as a moving direction and/or a velocity (or acceleration), acquired by an input device. In addition, the execution of the expanded functions may be designed to operate in conjunction with the operation habits of a use, such that the practicability and operation convenience of the interactive image system can be increased.

### SUMMARY

The present invention provides an interactive image system and an operating method thereof whose operation function may be expanded according to a characteristic parameter acquired by a second input device in conjunction with at least one pressed key of a first input device.

The present invention further provides an interactive image system and an operating method thereof, wherein in a first mode a second input device may execute the operation functions of a conventional mouse while in a second mode the second input device may execute expanding functions.

The present invention provides an operating method of an integrative image system including: displaying an image on an image display; continuously pressing at least one key of a first input device to enable an interactive image system to enter a second mode; acquiring a characteristic parameter with a second input device; comparing the characteristic parameter with a plurality of predetermined rules; and updating images shown by the image display according to the predetermined rule that the characteristic parameter matches.

The present invention further provides an operating method of an integrative image system including the steps of: controlling the interactive image system to enter a second mode with a first input device; detecting a velocity, an acceleration and/or a moving direction with a second input device; identifying a rule of the velocity, the acceleration and/or the moving direction; and controlling an image display to execute a corresponding function according to the rule.

Before entering the second mode, the operating method of the integrative image system of the present invention further includes the step of: controlling a cursor shown on the image display to a proper position, e.g. upon an object or a window, with the second input device.

The present invention further provides an integrative image system including an image display, a first input device, a second input device and a host. The first input device includes a plurality of keys for being used to input a control signal. The second input device is configured to acquire a characteristic parameter. The host controls the image display according to the control signal and the characteristic parameter, wherein when at least one key of the first input device is pressed, the first input device sends the control signal to the host to enable the host to compare the characteristic parameter acquired by the second input device with a plurality of predetermined rules, and to control the image display to execute a corresponding function according to the predetermined rule that the characteristic parameter matches.

In the interactive image system of the present invention and an operating method thereof, the first input device may be a keyboard while the second input device may be a mouse or an image sensing device.

In the interactive image system of the present invention and an operating method thereof, mode switching may be performed by pressing a predetermined key of the first input device, wherein in a first mode the second input device may execute conventional cursor controlling functions while in a second mode the characteristic parameter acquired by the second input device may be used for the operation of the expanding functions.

In the interactive image system of the present invention and an operating method thereof, the expanding functions include rotating an object, zooming (expanding or shrinking) an object or a window, scrolling or flipping pages.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of a conventional image display system.

FIG. 2 shows a block diagram of the interactive image system in accordance with an embodiment of the present invention.

FIG. 3 shows a schematic diagram of the interactive image system in accordance with an embodiment of the present invention.

FIG. 4 shows a schematic diagram of the interactive image system in accordance with another embodiment of the present invention.

FIG. 5 shows a flow chart of the operating method of the interactive image system in accordance with an embodiment of the present invention.

FIG. 6 shows a flow chart of the operating method of the interactive image system in accordance with another embodiment of the present invention.

FIG. 7a-7b shows a schematic diagram of a predetermined rule in the operating method of the interactive image system of the present invention.

FIG. 8a-8b shows a schematic diagram of another predetermined rule in the operating method of the interactive image system of the present invention.

FIG. 9a-9b shows a schematic diagram of another predetermined rule in the operating method of the interactive image system of the present invention.

FIG. 10a-10b shows a schematic diagram of another predetermined rule in the operating method of the interactive image system of the present invention.

FIG. 11a-11b shows a schematic diagram of another predetermined rule in the operating method of the interactive image system of the present invention.

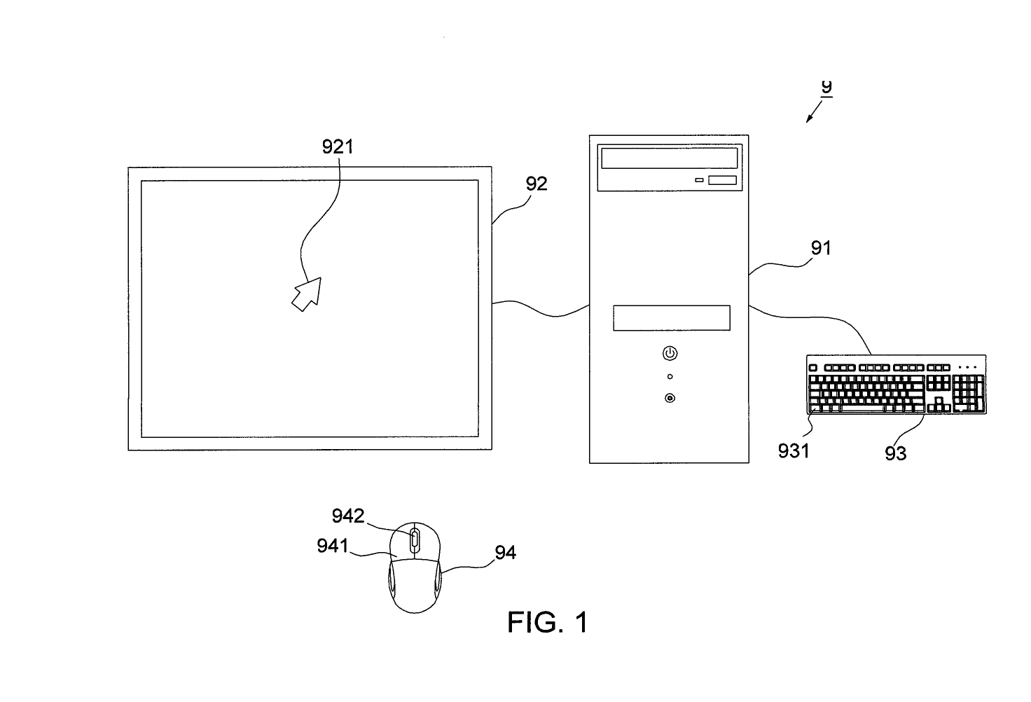

### DETAILED DESCRIPTION OF THE EMBODIMENT

It should be noticed that, wherever possible, the same reference numbers will be used throughout the drawings to refer to the same or like parts.

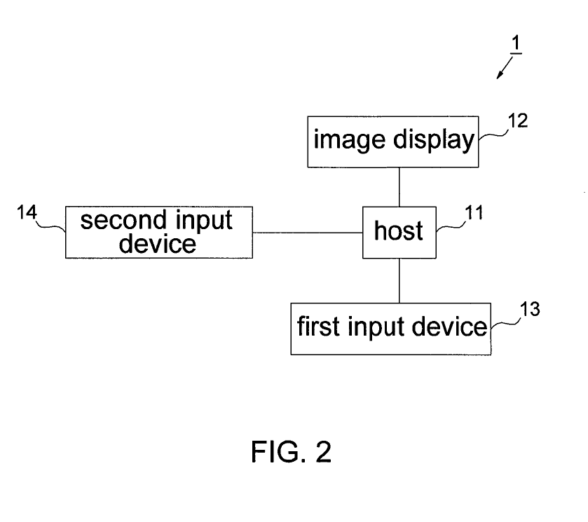

Please refer to FIG. 2, it shows a block diagram of the interactive image system 1 according to an embodiment of the present invention. The interactive image system 1 includes a host 11, an image display 12, a first input device 13 and a second input device 14. The host 11 is electrically connected to the image display 12 for controlling the display and update of images thereof. The first input device 13 may be electrically or wirelessly coupled to the host 11 and may include a plurality of keys for being pressed by a user (not shown) to input a control signal or symbols to the host 11 to correspondingly control the display of images of the image display 12; wherein the first input device 13 may be a keyboard. Embodiments of the second input device 14 include a mouse and an image sensing device. The second input device 14 may be electrically or wirelessly coupled to the host 11. The second input device 14 is for acquiring a characteristic parameter, e.g. a velocity, acceleration and a moving direction, and transmits detected results to the host 11 for correspondingly controlling the update of images shown on the image display 12 and controlling the motion of a cursor shown on the image display 12.

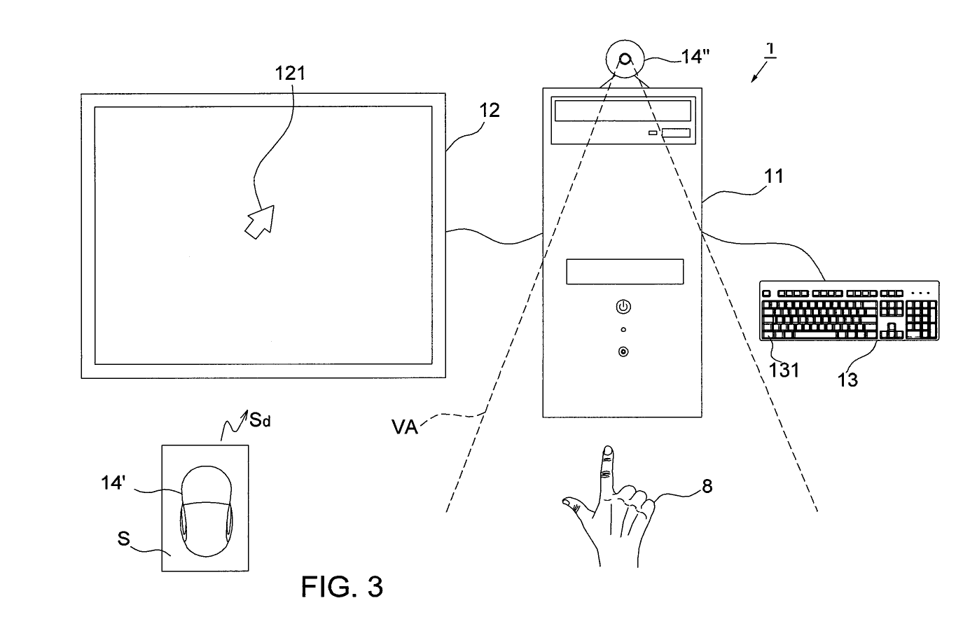

Please refer to FIG. 3, it shows a schematic diagram of the interactive image system 1 according to an embodiment of the present invention. The interactive image system 1 includes a host 11, an image display 12, a first input device 13 and a second input device 14 (e.g. a mouse 14′ or an image sensing device 14″), wherein the host 11 is separated from the image display 12 and a data line is connected therebetween for data communication. In another embodiment, the host 11 may communicate with the image display 12 through wireless communication.

The first input device 13, e.g. a keyboard, includes a plurality of keys 131 for being pressed by a user to input a control signal or symbols to the host 11 for correspondingly controlling the display of images of the image display 12. The second input device 14, e.g. a mouse 14′, is put on a surface S for being operated by a user (not shown) to detect a velocity, an acceleration and/or a moving direction of the second input device 14 (i.e. the mouse 14′) with respect to the surface S. The second input device 14 electrically or wirelessly transmits detected results to the host 11 for correspondingly controlling the motion of a cursor 121 and the update of images shown on the image display 12. The second input device 14 may calculate a velocity, an acceleration and/or a moving direction thereof with respect to the surface according to, for example, the correlation between successive images of the surface S captured by the second input device 14 to accordingly control the update of images shown by the image display 12.

The second input device 14 may also be an image sensing device 14″. The second input device 14 (i.e. the image sensing device 14″) acquires a characteristic parameter, e.g. a gesture, a velocity, an acceleration and/or a moving direction, of a pointer 8 inside a field of view VA thereof and electrically or wirelessly transmits detected results to the host 11 for correspondingly controlling the motion of a cursor 121 and the update of images shown on the image display 12. It is appreciated that although the pointer 8 is shown by the hand of a user in this embodiment, it is not a limitation of the present invention. In another embodiment, the pointer 8 may be any suitable pointer, e.g. a pen or a stick.

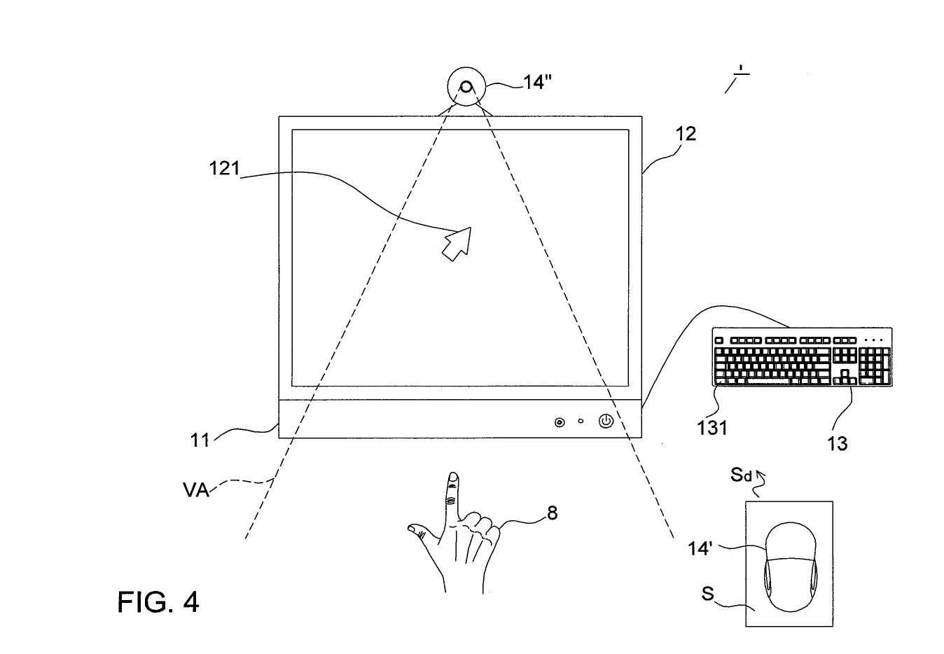

Please refer to FIG. 4, it shows the interactive mage system 1′ according to another embodiment of the present invention, wherein the host 11 is integrated in the image display 12. The interactive image system 1′ includes an image display 12 (including a host 11), a first input device 13 and a second input device 14. FIG. 4 and FIG. 3 are different in that the host 11 is integrated with the image display 12, and the function and operation of other components in FIG. 4 are similar to that in FIG. 3 and illustration thereof, and thus details will not be repeated herein.

It should be understood that, during operation, the second input device 14 in FIGS. 3 and 4 may be the mouse 14′ or the image sensing element 14″.

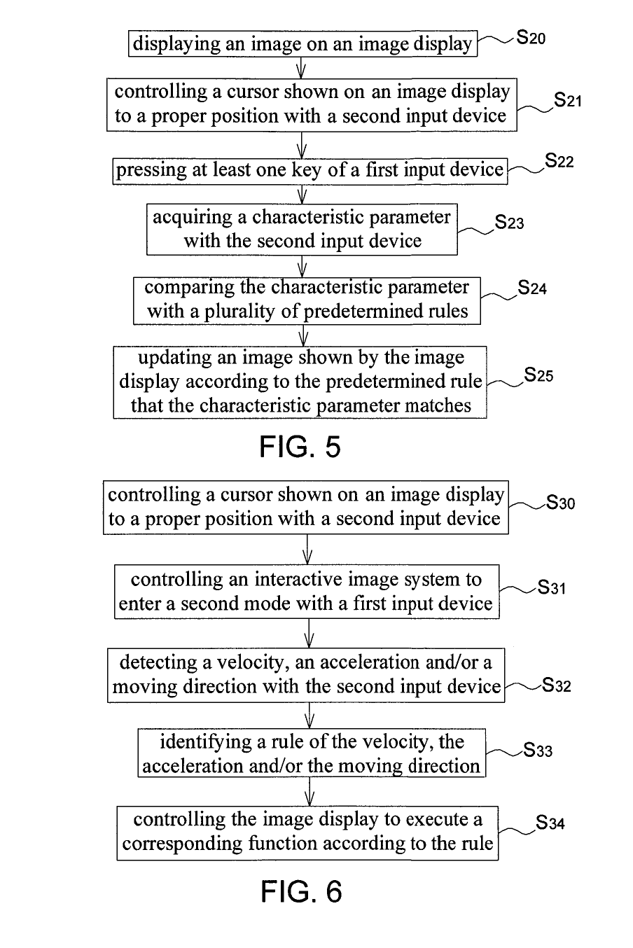

Please refer to FIG. 5, it shows a flow chart of the operating method of the interactive image system according to an embodiment of the present invention. The operating method includes the step of: displaying an image on an image display (Step S₂₀); controlling a cursor shown on the image display to a proper position with a second input device (Step S₂₁); continuously pressing at least one key of a first input device (Step S₂₂); acquiring a characteristic parameter with the second input device (Step S₂₃); comparing the characteristic parameter with a plurality of predetermined rules (Step S₂₄); and updating an image shown by the image display according to the predetermined rule that the characteristic parameter matches (Step S₂₅). Details of the operating method of the present invention will be illustrated by embodiments hereinafter.

It should be mentioned first that before the operating method of the present invention is practiced, the interactive image system 1 is operated in a first mode in which a user may utilize the second input device 14 to perform operating functions, e.g. controlling the motion of a cursor 121 shown on an image display 12, of a conventional mouse. When the user presses a predetermined key 131 of the first input device 13, the interactive image system 1 then enters a second mode in which the characteristic parameter acquired by the second input device 14 will be used to operate expanding function rather than to control the motion of the cursor 121.

Referring to FIGS. 3, 4 and 5 together, the present invention will be illustrated by assuming the second input device 14 is a mouse 14′. First, the image display 12 displays an image, which contains a cursor (Step S₂₀). In the first mode (i.e. the predetermined key 131 of the first input device 13 is not pressed), move the cursor 121 shown on the image display 12 to a proper position by using the second input device 14, e.g. moving the cursor 121 to upon an object or a window shown on the image display 12 (Step S₂₁). Next, press at least one key 131 of the first input device 13 to enable the interactive image system 1 to enter a second mode, wherein the key to be pressed may be preset according to software (Step S₂₂). Next, the second input device 14 captures a plurality of images of the surface S and acquires a characteristic parameter S_{d}, for example, but not limited to, a velocity, an acceleration and/or a moving direction, of the second input device 14 with respect to the surface S according to the images (Step S₂₃), wherein the characteristic parameter S_{d} may be obtained, for example, according to the correlation between successive images. The characteristic parameter S_{d} will be wirelessly or electrically transmit to the host 11. The host 11 compares the characteristic parameter with a plurality of predetermined rules, e.g. identifying whether the velocity is larger than a threshold, whether the acceleration is larger than a threshold and/or whether the moving direction matches a predetermined direction (Step S₂₄), wherein the predetermined rule will be illustrated by embodiments hereinafter. When the host 11 identifies that the characteristic parameter matches a predetermined rule, i.e. the velocity is larger than a predetermined threshold, the acceleration is larger than a predetermined threshold and/or the moving direction matches a predetermined direction, the host 11 updates images displayed by the image display 12 to execute a corresponding function according to the predetermined rule that the characteristic parameter matches, e.g. rotating an object displayed, zooming (i.e. expanding or shrinking) an object or a window displayed, scrolling screen or flipping pages (Step S₂₅).

It is appreciated that the characteristic parameters, e.g. the threshold of velocity, the threshold of acceleration and/or the moving direction (e.g. a transversal direction, a longitudinal direction, a diagonal direction, a clockwise direction or a counterclockwise direction), corresponding to each predetermined rule may be prestored in the host 11. In an embodiment, the characteristic parameters may be implemented as a look up table to be stored in the host 11. The host 11 compares the characteristic parameter acquired by the second input device 14 with the look up table to find out the predetermined rule that the characteristic parameter matches.

Referring to FIGS. 3, 4 and 5 together, the present invention will then be illustrated by assuming the second input device 14 is an image sensing device 14″, wherein the image sensing device 14″ may capture images by means of, e.g. a CCD image sensor or a CMOS image sensor. First, the image display 12 displays an image, which contains a cursor (Step S₂₀). In the first mode, the second input device 14 captures a plurality of images of a pointer 8 and moves the cursor 121 shown on the image display 121 to a proper position according to the image variation of the pointer 8 in the captured images, e.g. moving the cursor 121 to upon an object or a window shown on the image display 12 (Step S₂₁). Next, press at least one key 131 of the first input device 13 to enable the interactive image system 1 to enter a second mode (Step S₂₂). Next, the second input device 14 captures a plurality of images of the pointer 8 and acquires a characteristic parameter S_{d}, for example, but not limited to, a gesture, a velocity, an acceleration and/or a moving direction, of the pointer 8 (Step S₂₃), wherein the method for identifying gestures through image processing may refer to the disclosure in U.S. Pat. No. 7,295,707. The characteristic parameter S_{d} will be wirelessly or electrically sent to the host 11. The host 11 compares the characteristic parameter with a plurality of predetermined rules (Step S₂₄). When the host 11 identifies that the characteristic parameter matches a predetermined rule, e.g. the velocity is larger than a predetermined threshold, the acceleration is larger than a predetermined threshold, the moving direction matches a predetermined direction and/or the gesture matches a predetermined gesture, the host 11 updates images displayed by the image display 12 to execute a corresponding function according to the predetermined rule that the characteristic parameter matches (Step S₂₅), wherein a predetermined rule and its corresponding function will be described by exemplary embodiments hereinafter.

Please refer to FIG. 6, in another embodiment, the operating method of the interactive image system of the present invention includes the steps of: controlling a cursor shown on the image display to a proper position with a second input device (Step S₃₀); controlling the interactive image system to enter a second mode with a first input device (Step S₃₁); detecting a velocity, an acceleration and/or a moving direction with the second input device (Step S₃₂); identifying a rule of the velocity, the acceleration and/or the moving direction (Step S₃₃); and controlling an image display to execute a corresponding function according to the rule (Step S₃₄). In this embodiment, when the second input device is a mouse, identifying a rule of the velocity, the acceleration and/or the moving direction is to identify a rule of a velocity, an acceleration and/or a moving direction of the mouse with respect to a surface, whereas when the second input device is an image sensing device, identifying a rule of the velocity, the acceleration and/or the moving direction is to identify a rule of a velocity, an acceleration, a gesture and/or a moving direction of a pointer detected by the image sensing device. In addition, details of other steps of this embodiment are similar to those described in the embodiment mentioned above, and thus details will be not repeated herein.

Then the exemplary embodiments of expanding functions (i.e. predetermined rules) and corresponding operating methods performed by the interactive image system 1 of the present invention will be illustrated, and characteristic parameters corresponding to these expanding functions are prestored in the host 11, e.g. prestored in a memory included in the host 11. In the following illustration, it is assumed that the interactive image system 1 is initially operated in a first mode, i.e. the second input device 14 performs operating functions of a general mouse. When a user presses the predetermined key 131 of the first input device 13, the interactive image system 1 enters a second mode. At this moment, the characteristic parameters acquired by the second input device 14 will be compared with the predetermined rules stored in the host 11 for performing expanding functions rather than controlling the motion of the cursor 121.

### Screen Scroll or Page Up/Down Function

Please refer to FIGS. 3, 4, 7a and 7b, when a user would like to utilize the interactive image system 1 or 1′ to execute screen scroll or page up/down function, the user first presses a predetermined key 131 (may be preset as any key) of the first input device 13 to enable the interactive image system 1 or 1′ to enter a second mode. Next, the user moves the mouse 14′ or the pointer 8 upward or downward with a speed exceeding a predetermined threshold of velocity or acceleration to allow the second input device 14 to acquire an upward or downward characteristic parameter. The host 11 compares the acquired characteristic parameter with a plurality of predetermined rules, e.g. the velocity or acceleration exceeding a threshold, upward moving corresponding to upward or downward scrolling, and downward moving corresponding to downward or upward scrolling, prestored in the host 11. When the user's operation is recognized to be screen scroll or page change, the image display 12 is controlled to update images to show the corresponding function.

### Object Rotate Function

Please refer to FIGS. 3, 4, 8a and 8b, when a user would like to utilize the interactive image system 1 or 1′ to execute object rotate function, the user first moves the cursor 121 with the second input device 14 to upon the object to be rotated, and then presses a predetermined key 131 of the first input device 13 to enable the interactive image system 1 or 1′ to enter a second mode. Next, the user moves the mouse 14′ or the pointer 8 clockwise or counterclockwise with a speed exceeding a predetermined threshold of velocity or acceleration to allow the second input device 14 to acquire a clockwise or counterclockwise characteristic parameter. The host 11 compares the acquired characteristic parameter with a plurality of predetermined rules, e.g. the velocity or acceleration exceeding a threshold, clockwise moving corresponding to clockwise or counterclockwise object rotate, and counterclockwise moving corresponding to counterclockwise or clockwise object rotate, prestored in the host 11. When the user's operation is recognized to be object rotate, the image display 12 is controlled to update images to show the corresponding function.

### Object/Window Zoom Function

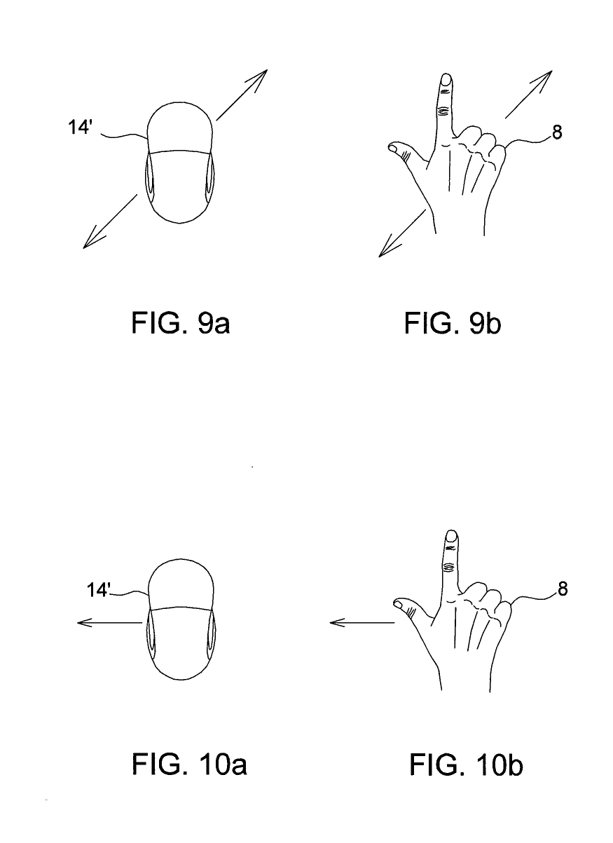

Please refer to FIGS. 3, 4, 9a and 9b, when a user would like to utilize the interactive image system 1 or 1′ to execute object or window zoom function, the user first moves the cursor 121 with the second input device 14 to upon the object or window to be zoomed (expanded or shrunk), and then presses a predetermined key 131 of the first input device 13 to enable the interactive image system 1 or 1′ to enter a second mode. Next, the user moves the mouse 14′ or the pointer 8 diagonally with a speed exceeding a predetermined threshold of velocity or acceleration to allow the second input device 14 to acquire a diagonal characteristic parameter. The host 11 compares the acquired characteristic parameter with a plurality of predetermined rules, e.g. the velocity or acceleration exceeding a threshold, upper right moving corresponding to object expand or shrink, and lower left moving corresponding to object shrink or expand, prestored in the host 11. When the user's operation is recognized to be object or window zoom, the image display 12 is controlled to update images to show the corresponding function.

### Page Flip Function

Please refer to FIGS. 3, 4, 10a and 10b, when a user would like to utilize the interactive image system 1 or 1′ to execute page flip function, the user first presses a predetermined key 131 of the first input device 13 to enable the interactive image system 1 or 1′ to enter a second mode. Next, the user moves the mouse 14′ or the pointer 8 leftward quickly with a speed exceeding a predetermined threshold of velocity or acceleration to allow the second input device 14 to acquire a leftward characteristic parameter. The host 11 compares the acquired characteristic parameter with a plurality of predetermined rules, e.g. the velocity or acceleration exceeding a threshold; high speed leftward moving corresponding to page flip, prestored in the host 11. When the user's operation is recognized to be page flip, the image display 12 is controlled to update images to show the corresponding function.

The above mentioned functions and operating methods (e.g. the operation and moving direction of the mouse 14′ and the pointer 8) are only exemplary and are not the limitation of the present invention. The interactive image system 1 and 1′ of the present invention may practice different operating functions according to different settings.

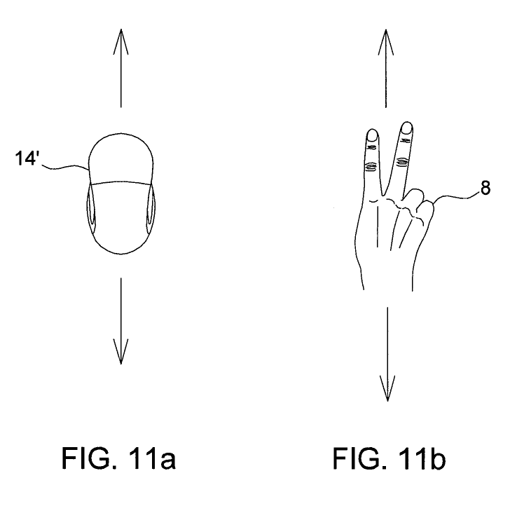

For example in the object/window zoom function, when the second input device 14 is a mouse 14′ as shown in FIG. 11a, the user also moves the cursor 121 with the second input device 14 to upon the object or window to be zoomed and then presses a predetermined key 131 of the first input device 13 to enable the interactive image system 1 or 1′ to enter a second mode. Next, the user moves the second input device 14 vertically with a speed exceeding a predetermined threshold of velocity or acceleration to allow the second input device 14 to acquire a vertical characteristic parameter. The host 11 compares the acquired characteristic parameter, including a moving direction and a velocity or acceleration, with a plurality of predetermined rules, e.g. the velocity or acceleration exceeding a threshold and/or the moving direction matching a predetermined direction, prestored in the host. When the user's operation is recognized to be object/window zoom, the image display 12 is controlled to update images to show the corresponding function.

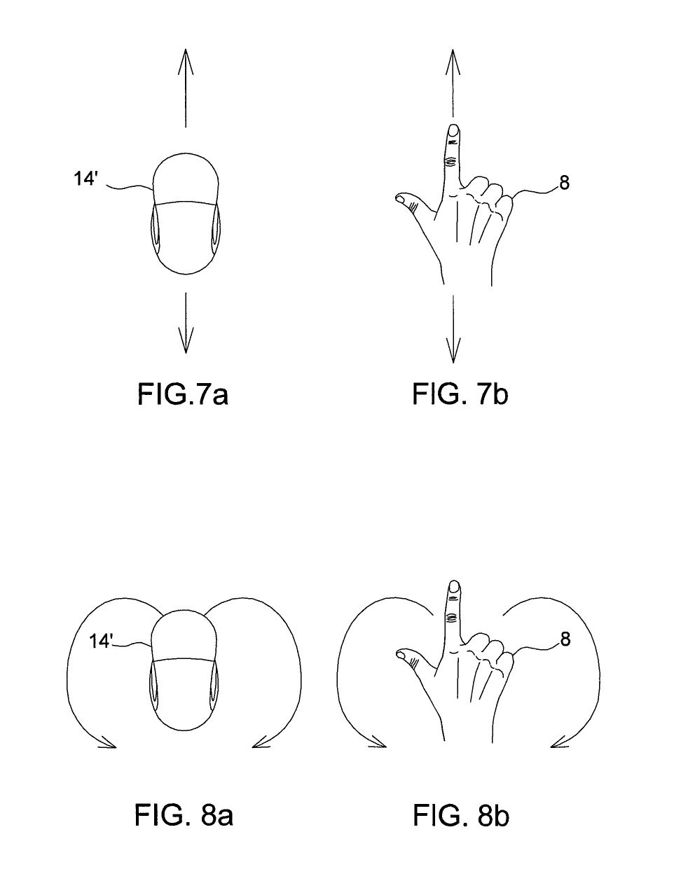

In another embodiment, when the second input device 14 is an image sensing device 14″ as shown in FIG. 11b, the user also moves the cursor 121 with the second input device 14 to upon the object or window to be zoomed and then presses a predetermined key 131 of the first input device 13 to enable the interactive image system 1 or 1′ to enter a second mode. Next, the user moves the pointer 8 vertically with a different gesture (different from the gesture shown in FIG. 7b). The host 11 compares the acquired characteristic parameter, including a velocity, an acceleration, a direction and a gesture, with a plurality of predetermined rules, e.g. the velocity or acceleration exceeding a predetermined threshold, the direction matching a predetermined direction and/or the gesture matching a predetermined gesture, prestored in the host. When the user's operation is recognized to be object/window zoom, the image display 12 is controlled to update images to show the corresponding function. It is appreciated that the gesture posed by the user is not limited to those shown in FIGS. 7b and 11b.

As mentioned above, as the mouse in a conventional image system has limited operating functions and thus is hard to fulfill various needs of a user. Therefore, the present invention further provides an interactive image system (FIGS. 2 and 4) and an operating method thereof (FIGS. 5 and 6) that may expand operating functions of an interactive image system according to a moving direction, an acceleration and/or a velocity detected by an input device thereby effectively increasing the practicability and the operation convenience of the interactive image system.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. An operating method of an interactive image system, comprising the steps of:
displaying an image on an image display;
continuously pressing at least one key of a first input device to enable an interactive image system to enter a second mode;
acquiring a characteristic parameter with a second input device;
comparing the characteristic parameter with a plurality of predetermined rules; and
updating an image shown by the image display according to the predetermined rule that the characteristic parameter matches.

2. The operating method as claimed in claim 1, wherein the second input device is a mouse; the characteristic parameter is a velocity, an acceleration and/or a moving direction of the mouse with respect to a surface.

3. The operating method as claimed in claim 2, wherein the predetermined rule is set as the velocity being larger than a threshold, the acceleration being larger than a threshold and/or the moving direction matching a predetermined direction.

4. The operating method as claimed in claim 1, wherein the second input device is an image sensing device; the characteristic parameter is a gesture, a velocity, an acceleration and/or a moving direction of a pointer acquired by the image sensing device.

5. The operating method as claimed in claim 4, wherein the predetermined rule is set as the velocity being larger than a threshold, the acceleration being larger than a threshold, the moving direction matching a predetermined direction and/or the gesture matching a predetermined gesture.

6. The operating method as claimed in claim 1, wherein before the step of continuously pressing at least one key of a first input device further comprises: controlling a cursor shown on the image display to a proper position with the second input device.

7. The operating method as claimed in claim 1, wherein the image shown by the image display is updated to show object rotating, object zooming, window zooming, scrolling or page flipping.

8. An operating method of an interactive image system, comprising the steps of:
controlling the interactive image system to enter a second mode with a first input device;
detecting a velocity, an acceleration and/or a moving direction with a second input device;
identifying a rule of the velocity, the acceleration and/or the moving direction; and
controlling an image display to execute a corresponding function according to the rule.

9. The operating method as claimed in claim 8, wherein the second input device is a mouse; the velocity, the acceleration and the moving direction are a velocity, an acceleration and a moving direction of the mouse with respect to a surface respectively.

10. The operating method as claimed in claim 9, wherein the step of identifying a rule of the velocity, the acceleration and/or the moving direction is to identify whether the velocity is larger than a threshold, whether the acceleration is larger than a threshold and/or whether the moving direction matches a predetermined direction.

11. The operating method as claimed in claim 8, wherein the second input device is an image sensing device; the velocity, the acceleration and the moving direction are a velocity, an acceleration and a moving direction of a pointer detected by the image sensing device respectively.

12. The operating method as claimed in claim 11, wherein the step of identifying a rule of the velocity, the acceleration and/or the moving direction is to identify whether the velocity is larger than a threshold, whether the acceleration is larger than a threshold and/or whether the moving direction matches a predetermined direction.

13. The operating method as claimed in claim 11, further comprising: identifying whether a gesture of the pointer matches a predetermined gesture.

14. The operating method as claimed in claim 8, wherein the corresponding function is set as rotating an object shown by the image display, zooming an object or a window shown by the image display, scrolling or flipping pages.

15. The operating method as claimed in claim 8, wherein before the step of controlling the interactive image system to enter a second mode with a first input device further comprises: controlling a cursor shown on the image display to a proper position with the second input device.

16. An interactive image system, comprising:
an image display;
a first input device, comprising a plurality of keys for being used to input a control signal;
a second input device, configured to acquire a characteristic parameter; and
a host, controlling the image display according to the control signal and the characteristic parameter, wherein when at least one key of the first input device is pressed, the first input device sends the control signal to the host to enable the host to compare the characteristic parameter acquired by the second input device with a plurality of predetermined rules, and to control the image display to execute a corresponding function according to the predetermined rule that the characteristic parameter matches.

17. The interactive image system as claimed in claim 16, wherein the first input device and second input device are wirelessly or electrically coupled to the host.

18. The interactive image system as claimed in claim 16, wherein the second input device is a mouse or an image sensing device.

19. The interactive image system as claimed in claim 18, wherein when the second input device is the mouse, the characteristic parameter is a velocity, an acceleration and/or a moving direction of the mouse with respect to a surface.

20. The interactive image system as claimed in claim 19, wherein the predetermined rule is set as the velocity being larger than a threshold, the acceleration being larger than a threshold and/or the moving direction matching a predetermined direction.

21. The interactive image system as claimed in claim 18, wherein when the second input device is the image sensing device, the characteristic parameter is a gesture, a velocity, an acceleration and/or a moving direction of a pointer detected by the image sensing device.

22. The interactive image system as claimed in claim 21, wherein the predetermined rule is set as the velocity being larger than a threshold, the acceleration being larger than a threshold, the moving direction matching a predetermined direction and/or the gesture matching a predetermined gesture.

23. The interactive image system as claimed in claim 16, wherein the first input device is a keyboard.

24. The interactive image system as claimed in claim 16, wherein the corresponding function is set as rotating an object shown by the image display, zooming an object or a window shown by the image display, scrolling or flipping pages.

25. The interactive image system as claimed in claim 16, wherein the host is integrated in the image display.
